(19) United States
(12) Patent Application Publication
(10) Pub. No.: US 2025/0207450 A1
(43) Pub. Date: Jun. 26, 2025

(54) Hood Mount Assembly

(71) Applicant: The Pullman Company, Milan, OH (US)

(72) Inventor: Troy P. RODECKER, Berlin Heights, OH (US)

(21) Appl. No.: 18/937,260

(22) Filed: Nov. 5, 2024

Related U.S. Application Data
(60) Provisional application No. 63/613,837, filed on Dec. 22, 2023.

(51) Int. Cl. E05F 7/00; B62D 25/12; E05F 7/04

(52) U.S. Cl. CPC E05F 7/005; B62D 25/12; E05F 7/04

(57) ABSTRACT

A hood mount includes a bracket, a plunger assembly, and a receiver assembly. The bracket includes a plurality of recesses and is adapted to be mounted to one of a vehicle body or a hood. The plunger assembly includes a plunger including a tapered surface and is adapted to be mounted to the other of the vehicle body or hood. The receiver assembly includes a body defining a tapered seat, a pair of apertures extending through the body, a pair of rods extending through the apertures, and a plurality of bushings fixed to the rods. A portion of the plurality of bushings are received in the plurality of recesses. In a first position, the tapered surface of the plunger is spaced apart from the tapered seat of the body. In a second position, the tapered surface of the plunger contacts the tapered seat of the body.

### CROSS-REFERENCE TO RELATED APPLICATION

This application claims the benefit of U.S. Provisional Application No. 63/613,837, filed on Dec. 22, 2023. The entire disclosure of the application referenced above is incorporated herein by reference.

### FIELD

The present disclosure relates to a hood mount for a vehicle. More particularly, the present disclosure describes a compliant hood mount for minimizing noise vibration and harshness associated with a vehicle hood moving relative to a vehicle body.

### BACKGROUND

The statements in this section merely provide background information related to the present disclosure and may not constitute prior art.

Vehicles, such as trucks, tractor-trailer trucks, heavy duty trucks, and buses, are often designed with a body structure and a hood. The hood may be movable between an open position and a closed position with respect to the body structure. It is desirable to have a vehicle including a moveable hood so that the hood may be secured to the body structure in the closed position (e.g., while driving or parked), while permitting an operator to optionally open or release the hood to the open position (e.g., to inspect and/or repair the engine of the vehicle). It is advantageous to have a hood mount system that releasably engages the hood to the body structure between the open and closed positions.

Typically, hoods have varied dimensional tolerances. Accordingly, it is desirable to secure the hood to the body structure and simultaneously account for such tolerances. If the fit between the hood and body is improper with too little clearance between components, the hood may not close properly resulting in scratches in paint and/or other structural wear in the hood and/or body. In contrast, if there is too much clearance between the hood and body, the hood may not properly protect under hood components. Importantly, when driving the vehicle, it is desirable that the hood be fixed to the body structure to prevent relative movement between the hood and body structure. While most, if not all, existing hood mounts limit the movement between the hood and body in a first or vertical direction so that the hood is not inadvertently released from the body, some known hood mounts may restrain movement of the hood in a second or fore-aft direction and/or third or cross-car direction relative to the body that may cause unwanted noise, such as squeaking, during vehicle operation.

Some hood mounts include a bracket fixed to the body structure and an elastomeric shoe engaged to a surface of the bracket. The sliding contact between the shoe and bracket may lead to undesirable noise during vehicle operation. A lubricant, such as grease, may be added to reduce the noise generation. This procedure, however, is messy and tedious to apply throughout vehicle operation.

Thus, the continued development of hood mounts has been directed to achieving a hood mount that is stiff in a first direction to improve durability and releasably secure a hood to a vehicle body, and compliant (while being devoid of sliding contact) in at least a second direction to improve noise during operation of the vehicle.

### SUMMARY

This section provides a general summary of the disclosure and is not a comprehensive disclosure of its full scope or all of its features.

The present disclosure provides the art with a hood mount for a vehicle including a hood movably coupled to a vehicle body. The hood mount includes a bracket, a plunger assembly, and a receiver assembly. The bracket includes first, second, third, and fourth recesses. The bracket also includes a flange adapted to be mounted to one of the vehicle body or the hood. The plunger assembly includes a plate, a post, and a plunger including a tapered surface. The plate is adapted to be mounted to the other of the vehicle body or hood. The post extends from a surface of the plate. The receiver assembly includes a body, a first aperture, a second aperture, a first rod, a second rod, and a plurality of polymeric bushings. The body defines a tapered seat. The first aperture and the second aperture extend through the body. The first rod extends through the first aperture and the second rod extends through the second aperture. The first rod includes a first end and an opposite second end. The second rod includes a third end and opposite fourth end. The plurality of polymeric bushings include a first polymeric bushing fixed to the first end of the first rod, a second polymeric bushing fixed to the second end of the first rod, a third polymeric bushing fixed to the third end of the second rod, and a fourth polymeric bushing fixed to the fourth end of the second rod. The first polymeric bushing is received in the first recess. The second polymeric bushing is received in the second recess. The third polymeric bushing is received in the third recess. The fourth polymeric bushing is received in the fourth recess. In a first position, the tapered surface of the plunger is spaced apart from the tapered seat of the body. In a second position, the tapered surface of the plunger contacts the tapered seat of the body.

The present disclosure further provides the art with a hood mount for a vehicle including a hood movably coupled to a vehicle body. The hood mount includes a bracket, a plunger assembly, and a receiver assembly. The bracket includes a first recess, a second recess, a third recess, and a fourth recess. The bracket also includes a flange adapted to be mounted to one of the vehicle body or the hood. The plunger assembly includes a plate, a post, and a plunger including a tapered surface. The plate is adapted to be mounted to the other of the vehicle body or hood. The post extends from a surface of the plate. The receiver assembly includes a body, a first aperture, a second aperture, a first rod and a second rod. The body defines a tapered seat. The first aperture and the second aperture extend through the body. The first rod includes a first bottom portion, a first end and an opposite second end. The second rod includes a second bottom portion, a third end and opposite fourth end. The first bottom portion of the first rod extends through the first aperture and the second bottom portion of the second rod extends through the second aperture. The receiver assembly further includes a first polymeric bushing, a second polymeric bushing, a third polymeric bushing, a fourth polymeric bushing, a fifth polymeric bushing, and a sixth polymeric bushing. The first polymeric bushing is fixed to the first end of the first rod and received in the first recess. The second polymeric bushing is fixed to the second end of the first rod and received in the second recess. The third polymeric bushing is fixed to the first bottom portion of the first rod. The fourth polymeric bushing is fixed to the third end of the second rod and received in the third recess. The fifth polymeric bushing is fixed to the fourth end of the second rod and received in the fourth recess. The sixth polymeric bushing is fixed to the second bottom portion of the second rod. In a first position, the tapered surface of the plunger is spaced apart from the tapered seat of the body. In a second position, the tapered surface of the plunger contacts the tapered seat of the body.

The present disclosure further provides the art with a hood mount for a vehicle including a hood movably coupled to a vehicle body. The hood mount includes a bracket, a plunger assembly, and a receiver assembly. The bracket includes first, second, third, and fourth recesses. The bracket also includes a flange adapted to be mounted to one of the vehicle body or the hood. The plunger assembly includes a plate, a post, and a plunger defining a tapered depression. The plate is adapted to be mounted to the other of the vehicle body or hood. The post extends perpendicularly from a surface of the plate. The receiver assembly includes a receiver body, a first aperture, a second aperture, a first rod, a second rod, and a plurality of polymeric bushings. The receiver body includes a tapered protrusion. The first aperture and the second aperture extend through the receiver body. The first rod extends through the first aperture and the second rod extends through the second aperture. The first rod includes a first end and an opposite second end. The second rod includes a third end and opposite fourth end. The plurality of polymeric bushings include a first polymeric bushing fixed to the first end of the first rod, a second polymeric bushing fixed to the second end of the first rod, a third polymeric bushing fixed to the third end of the second rod, and a fourth polymeric bushing fixed to the fourth end of the second rod. The first polymeric bushing is received in the first recess. The second polymeric bushing is received in the second recess. The third polymeric bushing is received in the third recess. The fourth polymeric bushing is received in the fourth recess. In a first position, the tapered depression of the plunger is spaced apart from the tapered protrusion of the receiver body. In a second position, the tapered depression of the plunger contacts the tapered protrusion of the receiver body.

Further areas of applicability will become apparent from the description provided herein. The description and specific examples in this summary are intended for purposes of illustration only and are not intended to limit the scope of the present disclosure.

### BRIEF DESCRIPTION OF DRAWINGS

The drawings described herein are for illustrative purposes only of selected embodiments and not all possible implementations, and are not intended to limit the scope of the present disclosure.

FIG. 1 is a schematic of a vehicle including a hood mount in accordance with the present disclosure when a hood is in a closed position;

FIG. 2 is a schematic of the vehicle of FIG. 1 when the hood is in an open position;

FIG. 3 is a perspective view of the hood mount in accordance with the present disclosure;

FIG. 4 is an exploded perspective view of the hood mount of FIG. 3;

FIG. 5 is an end view of the hood mount of FIG. 3;

FIG. 6A is a cross-sectional view of the hood mount of FIG. 5 in a first position having a taller adjustment, taken along line 6-6 of FIG. 5;

FIG. 6B is a cross-sectional view of the hood mount of FIG. 5 in a second position having a shorter adjustment, taken along line 6-6 of FIG. 5;

FIG. 7 is a side-view of the hood mount of FIG. 3;

FIG. 8 is a cross-sectional view of the hood mount of FIG. 7, taken along line 8-8 of FIG. 7;

FIG. 9 is a cross-sectional view of the hood mount of FIG. 7, taken along line 9-9 of FIG. 7; and

FIG. 10 is a cross-sectional view of another hood mount in accordance with the present disclosure.

Corresponding reference numerals indicate corresponding parts throughout the several views of the drawings.

### DETAILED DESCRIPTION

Example embodiments will now be described more fully with reference to the accompanying drawings.

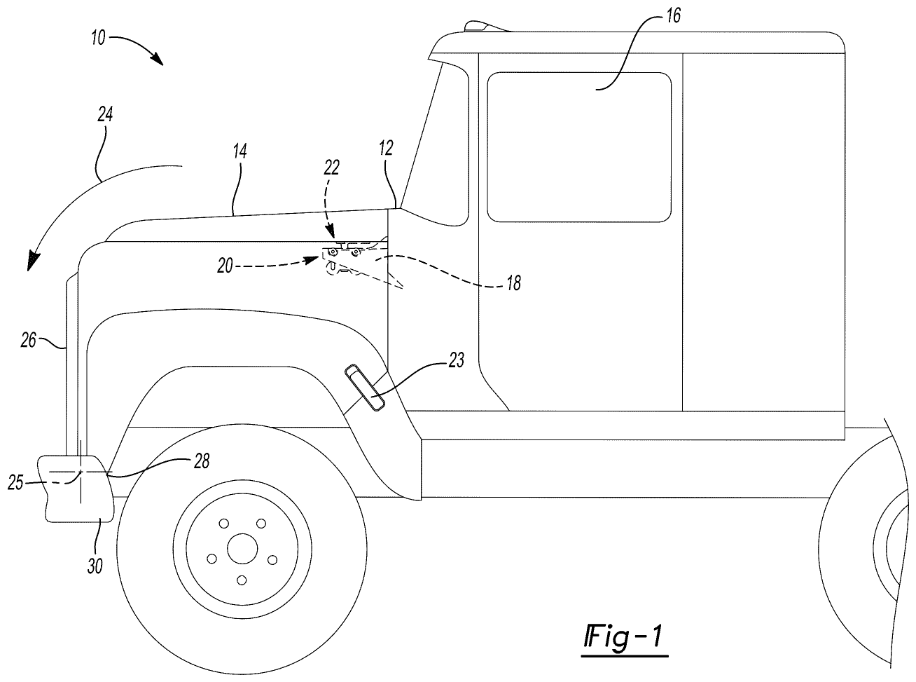

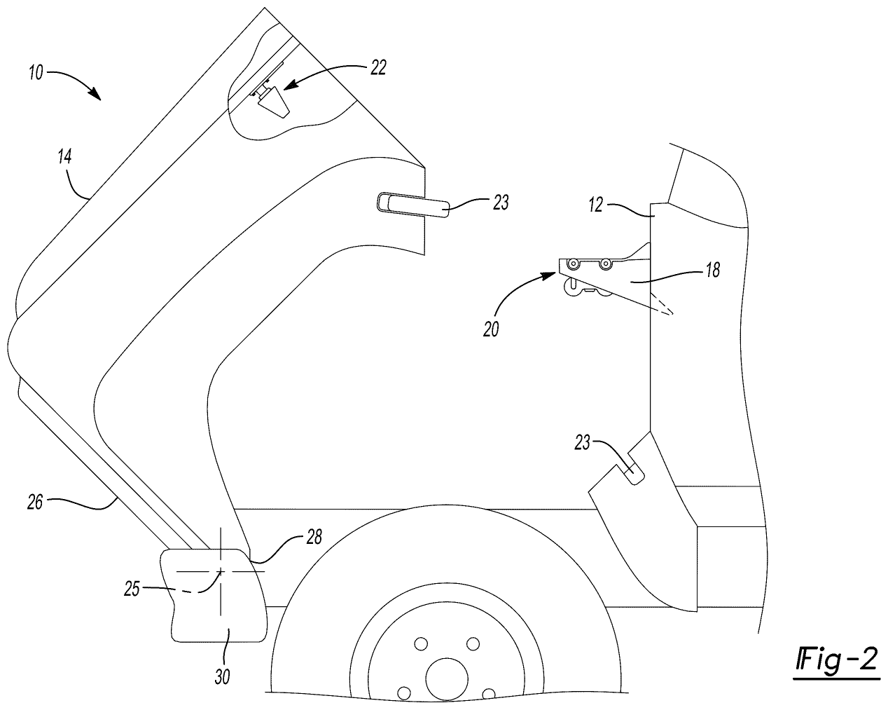

Referring now to the drawings in which like reference numerals designate like or corresponding parts throughout the several views, there is illustrated in FIG. 1 and FIG. 2, a vehicle 10 including a body 12 and a hood 14. Body 12 may cooperate with other structures in vehicle 10 to define a passenger compartment 16 and provide the desired strength characteristics of vehicle 10. Hood 14 is movable between a first or closed position (FIG. 1) and a second or open position (FIG. 2) relative to body 12.

Vehicle 10 includes a hood mount 18 movably coupled to body 12. A first portion 20 of hood mount 18 is mounted to body 12. A second portion 22 of hood mount 18 is mounted to hood 14. In the closed position (FIG. 1), first portion 20 is engaged with second portion 22 to releasably secure hood 14 to body 12. A latch mechanism 23 (e.g., a bungee, a tie down strap, a catch and lever, fasteners, etc.) may removably engage with hood 14 and body 12 to further secure hood 14 to body 12.

Hood 14 is adapted to pivot in a first rotational direction 24 about a pivot axis 25. Pivot axis 25 may be positioned at a front end 26 of vehicle 10 and a distal end 28 of hood 14. For example, pivot axis 25 may be positioned between distal end 28 of hood 14 and a front bumper 30 of vehicle 10. In the open position (FIG. 2), hood 14 is rotated about pivot axis 25 (e.g., in a forward direction). An operator of vehicle 10 may facilitate the release of second portion 22 from first portion 20 by opening or moving hood 14 about pivot axis 25 to the open position (FIG. 2) (e.g., operator may disengage latch mechanism 23 and move hood 14 from the closed position to the open position). In the open position, second portion 22 is not engaged to first portion 20. Conversely, the operator may facilitate the engagement of second portion 22 and first portion 20 by closing or moving hood 14 about pivot axis 25 to the closed position (FIG. 1) (and optionally further engage latch mechanism 23).

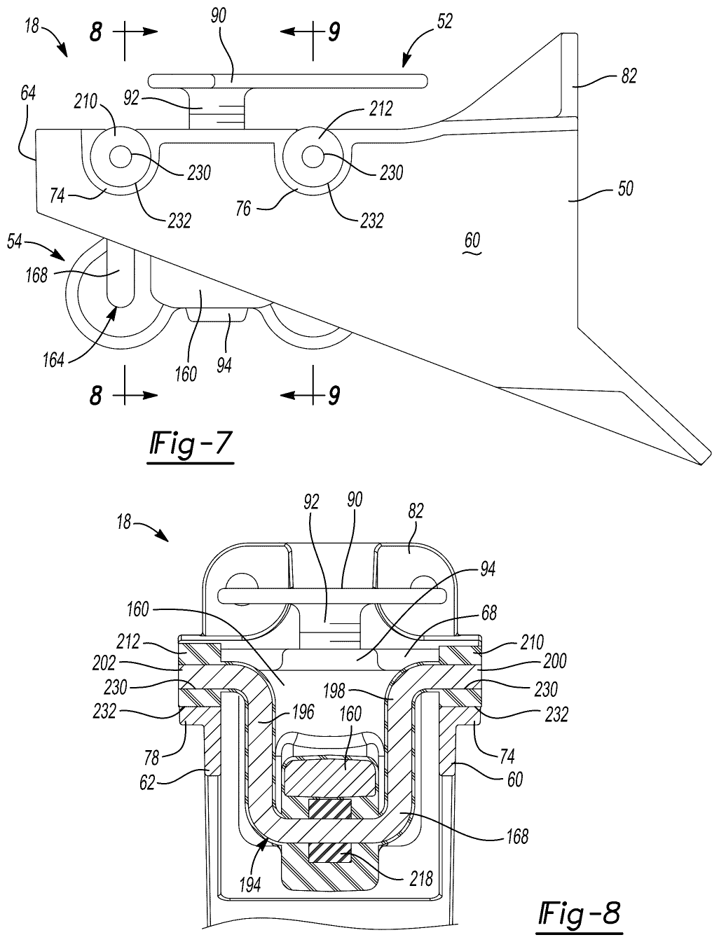

Referring now to FIGS. 3-9, hood mount 18 includes a bracket 50, a plunger assembly 52, and a receiver assembly 54. Bracket 50 includes two sets of parallel walls, including a first wall 60, an opposite second wall 62, a third wall 64, and an opposite fourth wall 66. First wall 60, second wall 62, third wall 64, and fourth wall 66 may be joined to define a cavity 68 therebetween. Typically, first wall 60, second wall 62, third wall 64 and fourth wall 66 are integrally formed in a unitary structure.

A first or top surface 70 of bracket 50 may define a plurality of recesses 72. The plurality of recesses 72 may include a first recess 74 and a second recess 76 disposed on first wall 60 and a third recess 78 and a fourth recess 80 disposed on second wall 62.

Bracket 50 is adapted to mount to one of body 12 (FIG. 1 and FIG. 2) or hood 14. In the configuration shown in FIGS. 1 and 2, bracket 50 is mounted to body 12. Referring back to FIGS. 3-9, bracket 50 may be mounted to one of body 12 or hood 14 via a flange 82. Flange 82 extends from fourth wall 66. Flange 82 may define a plurality of apertures 84. Plurality of apertures 84 may receive fasteners (e.g., bolts, screws, rivets, pins, etc.) to fix bracket 50 to body 12 or hood 14.

Bracket 50 may be formed of a metal (e.g., aluminum, steel, titanium, alloys thereof, or combinations thereof). Alternately, bracket 50 may be formed of a plastic or a composite (e.g., a carbon fiber composite). Bracket 50 may be tailored to meet the desired strength and stiffness characteristics of hood mount 18 based on the material and configuration of bracket 50.

Plunger assembly 52 includes a plate 90, a post 92, and a plunger 94. Plunger assembly 52 is adapted to mount to the other of body 12 or hood 14 (i.e., when bracket 50 is mounted to body 12 plunger assembly 52 is mounted to hood 14, and vice versa). In the configuration shown in FIGS. 1 and 2, plunger assembly 52 is mounted to hood 14. Plunger assembly 52 may be mounted to one of body 12 or hood 14 via plate 90.

Plate 90 includes a body 91 having a first surface 96 and an opposite second surface 98. In the configuration shown in FIGS. 3-9, plate 90 has a generally triangular shape, though other shapes are possible. Plate 90 includes a central aperture 100 and a plurality of mounting apertures 102 extending therethrough. Central aperture 100 may be adapted to hang or mount hood 14 to racks during vehicle assembly, such as during e-coating and/or painting processes. Plurality of mounting apertures 102 may receive fasteners (e.g., bolts, screws, rivets, pins, etc.) to fix plate 90 to body 12 or hood 14. In one example, plurality of mounting apertures 102 includes three apertures arranged in a 3 M8 bolt pattern.

Plate 90 may be formed of a metal (e.g., aluminum, steel, titanium, alloys thereof, or combinations thereof). Alternately, plate 90 may be formed of a plastic or a composite (e.g., a carbon fiber composite). Plate 90 may be tailored to meet the desired strength and stiffness characteristics of hood mount 18 based on the material and the configuration of plate 90.

Post 92 extends perpendicularly from second surface 98 of plate 90. Post 92 may be positioned relatively between mounting apertures 102. As will be described in greater detail below, post 92 movably engages with plunger 94. Post may include a helical ridge (e.g., a male thread) extending radially around an outer surface 104 of post 92 to improve engagement between post 92 and plunger 94. In some configurations, post 92 is integrally formed with plate 90.

Post 92 may be formed of a metal (e.g., aluminum, steel, titanium, alloys thereof, or combinations thereof). Alternately, post 92 may be formed of a plastic or a composite (e.g., a carbon fiber composite). Post 92 may be tailored to meet the desired strength and stiffness characteristics of hood mount 18 based on the material and the configuration of post 92.

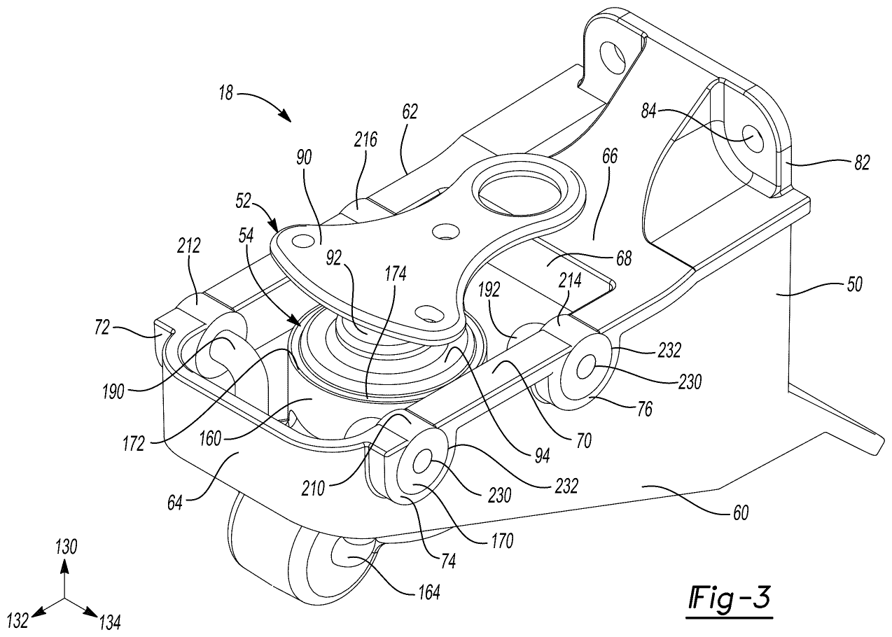

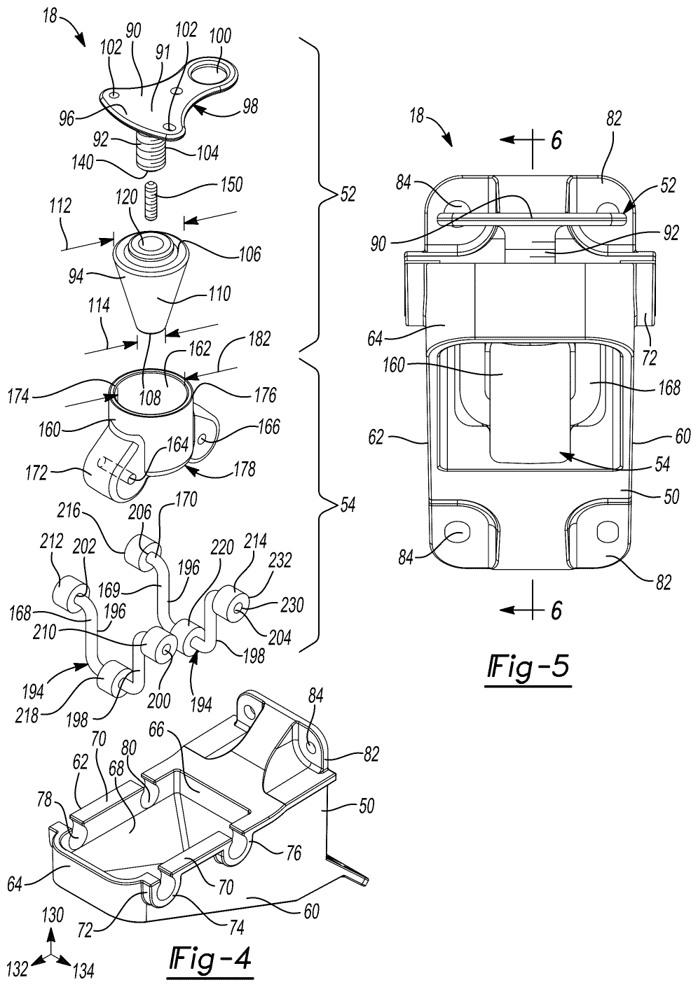

Plunger 94 includes a first or top end 106, a second or bottom end 108, and a tapered surface 110 extending between top end 106 and bottom end 108. While the figures depict tapered surface 110 being a conical surface, it should be appreciated that other tapered shapes and configurations are contemplated (e.g., plunger 94 may have a pyramidal and/or polyhedron shape). As best shown in FIG. 4, plunger 94 has a first diameter 112 at top end 106 and a second diameter 114 at bottom end 108. Tapered surface 110 is tapered at a first angle (not shown) between top end 106 and bottom end 108 such that first diameter 112 is larger than second diameter 114. As will be described in greater detail below, the first angle of tapered surface 110 is steep enough to allow easy engagement of plunger assembly 52 to receiver assembly 54 to secure hood 14 to body 12 in the closed position (e.g., when an operator moves hood 14 into the closed position) and shallow enough to allow disengagement of plunger assembly 52 and receiver assembly 54 when sufficient force is applied (e.g., when an operator moves hood 14 into the open position). The first angle may be greater than or equal to about 15 degrees to less than or equal to about 75 degrees (e.g., greater than or equal to about 20 degrees, greater than or equal to about 25 degrees, greater than or equal to about 30 degrees, greater than or equal to about 35 degrees, greater than or equal to about 40 degrees, greater than or equal to about 45 degrees, greater than or equal to about 50 degrees, greater than or equal to about 55 degrees, greater than or equal to about 60 degrees, greater than or equal to about 65 degrees, or optionally greater than or equal to about 70 degrees). More narrowly, first angle may be greater than or equal to about 50 degrees to less than or equal to about 70 degrees. In the configuration shown in FIGS. 3-9, the first angle is about 60 degrees.

Plunger 94 includes an aperture 120 extending therethrough between top end 106 and bottom end 108. Aperture 120 receives a portion of post 92 therein. Plunger 94 may include a helical depression (e.g., a female thread) extending radially around an inner surface 122 of plunger 94 to improve engagement between post 92 and plunger 94.

Plunger 94 is formed of a metal (e.g., aluminum, steel, titanium, alloys thereof, or combinations thereof). Alternately, plunger 94 may be formed of a plastic or a composite (e.g., a carbon fiber composite). Plunger 94 may be tailored to meet the desired strength and stiffness characteristics of hood mount 18 based on the material and the configuration of plunger 94.

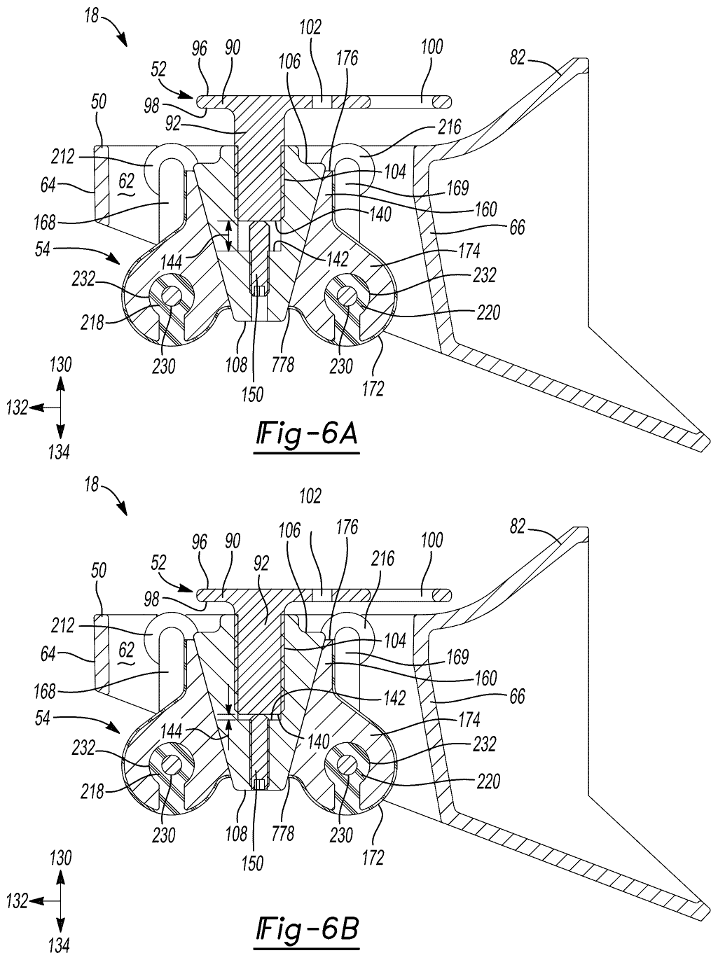

Post 92 is threadingly received within plunger 94 and moveable between a first position (FIG. 6A) and a second position (FIG. 6B). Post 92 may be rotated relative to plunger 94 to move post 92 between the first position and the second position in a first direction 130. In the first position (FIG. 6A), a distal surface 140 (e.g., an annular surface) of post 92 may be spaced apart from an interior step 142 of aperture 120. In the second position (FIG. 6B), distal surface 140 of post 92 may be in contact with interior step 142 of aperture 120. A dimension 144 between the first position and the second position is about 10 millimeters (mm). In other words, post 92 has an adjustment in the first direction 130 (e.g., a vertical adjustment) of about ±10 mm relative to plunger 94 between the first and second positions. A vertical adjustment of about ±10 mm accounts for variation or tolerances within hood 14.

Plunger assembly 52 may further include a locking mechanism 150 disposed and/or embedded within plunger 94. Locking mechanism 150 may engage with post 92 and plunger 94 to prevent rotation of post 92 relative to plunger 94. Locking mechanism 150 may be driven into engagement with distal surface 140 of post 92 and movably received within aperture 120 of plunger 94. In the configuration shown in FIGS. 3-9, locking mechanism 150 includes a set screw, however, other configurations are possible. For example, locking mechanism 150 may include, a bolt, stud, lock nut, etc.

With renewed reference to FIGS. 3-9, receiver assembly 54 includes a body 160 (e.g., a trolley body) defining a tapered seat 162 (e.g., a depression having a tapered shape). While the figures depict tapered seat 162 having a conical shape, other tapered shapes and configurations are contemplated (e.g., a seat that has a pyramidal and/or polyhedron shape). The shape of tapered seat 162 of body 160 may be complimentary to the shape of tapered surface 110 of plunger 94.

Body 160 further includes a first aperture 164, a second aperture 166, a first rod 168 extending through first aperture 164 and a second rod 169 extending through second aperture 166, and a plurality of polymeric bushings 170. Receiver assembly 54 may be at least partially disposed in cavity 68 of bracket 50.

Body 160 may be formed of a metal (e.g., aluminum, steel, titanium, alloys thereof, or combinations thereof). Alternately, body 160 may be formed of a plastic or a composite (e.g., a carbon fiber composite). In some configurations, body 160 may include an outer shell 172 and an inner sleeve 174 including the tapered seat 162. In some configurations, both outer shell 172 and inner sleeve 174 are formed of independently selected metals. When inner sleeve 174 is formed of a metal, a surface of tapered seat 162 may be coated (e.g., e-coated and/or coated with an elastomeric material). Preferably, the entire surface of tapered seat 162 is coated. Coating tapered seat 162 provides a body 160 having desired strength and stiffness characteristics while improving or reducing friction and noise between plunger assembly 52 and receiver assembly 54 when plunger 94 is received in tapered seat 162 (see, e.g., FIGS. 6A and 6B). Alternately, outer shell 172 is formed of a metal and inner sleeve 174 is formed of an elastomeric material (e.g., rubber).

Outer shell 172 and inner sleeve 174 may be joined or bonded (e.g., by over molding, press fitting, adhesion bonding, etc.) such that there is no relative motion between outer shell 172 and inner sleeve 174. Alternately, outer shell 172 and inner sleeve 174 may be integrally formed as a unitary body. Body 160 may define a third aperture (not shown) (e.g., an aperture extending through outer shell 172 and inner sleeve 174). The third aperture may permit trapped water to drain from hood mount 18.

Body 160 includes a third or top end 176 and a fourth or bottom end 178. Tapered seat 162 may extend between top end 176 and bottom end 178. As best shown in FIG. 4, body 160 has a third diameter 182 at top end 176 (e.g., a diameter of inner sleeve 174 at top end 176) and a fourth diameter (not shown) at bottom end 178. Tapered seat 162 is tapered at a second angle (not shown) between top end 176 and bottom end 178 such that third diameter 182 is larger than fourth diameter 184. The second angle of tapered seat 162 is complimentary to the first angle of tapered surface 110 of plunger 94. The second angle may be greater than or equal to about 15 degrees to less than or equal to about 75 degrees (e.g., greater than or equal to about 20 degrees, greater than or equal to about 25 degrees, greater than or equal to about 30 degrees, greater than or equal to about 35 degrees, greater than or equal to about 40 degrees, greater than or equal to about 45 degrees, greater than or equal to about 50 degrees, greater than or equal to about 55 degrees, greater than or equal to about 60 degrees, greater than or equal to about 65 degrees, or optionally greater than or equal to about 70 degrees). More narrowly, the second angle may be greater than or equal to about 50 degrees to less than or equal to about 70 degrees. In the configuration shown in FIGS. 3-9, the second angle is about 60 degrees.

Body 160 includes first aperture 164 and second aperture 166 extending therethrough. In the configuration shown in FIGS. 3-9, first aperture 164 and second aperture 166 are formed in lobes extending radially outward from body 160. It can be appreciated that other shapes and configurations of the first aperture 164 and the second aperture 166 are possible. In some configurations, body 160 may include more than two apertures, such as greater than or equal to three apertures, optionally greater than or equal to four apertures, optionally greater than or equal to five apertures, or optionally greater than or equal to ten apertures.

Each of first rod 168 and second rod 169 include a bottom portion 194, a first leg 198 extending orthogonally from bottom portion 194, and an opposite second leg 196 extending orthogonally from bottom portion 194. First rod 168 extends through first aperture 164 (e.g., at bottom portion 194). Second rod 169 extends through second aperture 166 (e.g., at bottom portion 194). First rod 168 includes a first end 200 extending in a first direction from first leg 198 and an opposite second end 202 extending in an opposite second direction from second leg 196. Second rod 169 includes a third end 204 extending in a third direction from first leg 198 and an opposite fourth end 206 extending in a fourth direction from the second leg 196. In the configuration shown in FIGS. 3-9, first rod 168 and second rod 169 are U-shaped. While two rods are shown in the configuration of FIGS. 3-9, receiver assembly 54 may include more than two rods, such as greater than or equal to three rods, optionally greater than or equal to four rods, or optionally greater than or equal to five rods.

The figures depict the entire periphery of the first rod 168 and the second rod 169 being encapsulated by an elastomer. It should be appreciated, however, that this configuration is merely exemplary. It is contemplated that, in an alternate arrangement, only portions of rods are encapsulated by elastomer and/or surrounded by the plurality of polymeric bushings 170.

The plurality of polymeric bushings 170 include a first polymeric bushing 210 fixed to first end 200 of first rod 168, a second polymeric bushing 212 fixed to second end 202 of first rod 168, a third polymeric bushing 214 fixed to third end 204 of second rod 169, and a fourth polymeric bushing 216 fixed to fourth end 206 of second rod 169. The plurality of polymeric bushings 170 further includes a fifth polymeric bushing 218 fixed to bottom portion 194 of first rod 168 and a sixth polymeric bushing 220 fixed to bottom portion 194 of second rod 169. In some configurations, the plurality of polymeric bushings 170 may include less than six polymeric bushings, such less than or equal to five polymeric bushings, optionally less than or equal to four polymeric bushings, or optionally less than or equal to three polymeric bushings. Alternately, the plurality of polymeric bushings 170 may include greater than six polymeric bushings, such as greater than or equal to seven polymeric bushings, optionally greater than or equal to eight polymeric bushings, or optionally greater than or equal to ten polymeric bushings.

Each of the plurality of polymeric bushings 170 are formed of an elastomeric material (e.g., a rubber). It is contemplated that, in an alternate arrangement, one or more bearings is used in addition or as an alternate to the plurality of polymeric bushings 170.

Each of the plurality of polymeric bushings 170 may have a first stiffness in the radial direction which corresponds to the first or vertical direction 130. The first stiffness may be relatively high to releasably secure hood 14 to body 12 and prevent relative movement between hood 14 and body 12 when hood 14 is in the closed position (FIG. 1).

Each of the plurality of polymeric bushings 170 may have a second stiffness in a torsional direction which corresponds to the second or fore-aft direction 132 of movement of body 160. The fore-aft direction is the straight-line direction of vehicle travel. The second stiffness may be a relatively low stiffness to allow movement between components of hood mount 18 in the second direction 132. Permitting movement (e.g., movement via flexion of the plurality of polymeric bushings 170) between components in hood mount 18 in the second direction 132 reduces or eliminates squeaking and/or noise exhibited between components when vehicle 10 is in motion.

Each of the plurality of polymeric bushings 170 may have a third stiffness in an axial direction of the bushing which corresponds to the third or cross-car direction 134. The third stiffness may be greater than the second stiffness and lower than the first stiffness.

In this way, the plurality of polymeric bushings 170 are radially stiff and torsionally compliant. This allows the plurality of polymeric bushings 170 to act as a spring to selectively permit movement between hood 14 and body 12 in at least the second direction 132 when hood 14 is in the closed position (FIG. 1). It can be appreciated that movement between components in hood mount 18 in the second direction 132 is a result of flexion of the polymeric bushings 170 (e.g., a flexion that is tailored to the desired stiffness characteristics of the elastomeric material in the first direction 130, second direction 132, and/or third direction 134) and not from components of hood mount 18 sliding and/or rolling relative to each other in the second direction 132 or third direction 134.

Each of the polymeric bushings 170 has an inner diameter 230 and an outer diameter 232. Inner diameter 230 is fixed to a portion of first rod 168 or the second rod 169 (e.g., by over molding, press fitting, adhesion bonding, etc.) such that there is no relative motion between inner diameter 230 and one of first rod 168 or second rod 169. Inner diameter 230 of first polymeric bushing 210 is fixed to first end 200 of first rod 168. Inner diameter 230 of second polymeric bushing 212 is fixed to second end 202 of first rod 168. Inner diameter 230 of third polymeric bushing 214 is fixed to third end 204 of second rod 169. Inner diameter 230 of fourth polymeric bushing 216 is fixed to fourth end 206 of second rod 169. Inner diameter 230 of fifth polymeric bushing 218 is fixed to bottom portion 194 of first rod 168. Inner diameter 230 of sixth polymeric bushing 220 is fixed to bottom portion 194 of second rod 169.

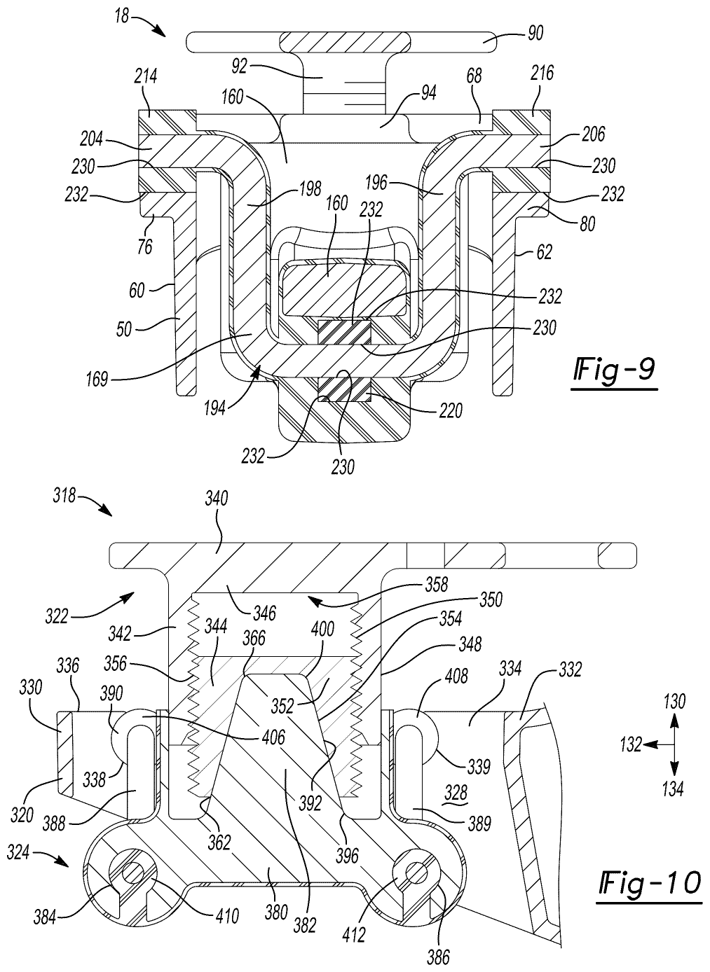

Referring to FIG. 3, a first portion of the plurality of polymeric bushings 170 may be at least partially received in plurality of recesses 72 of bracket 50. Specifically, outer diameter 232 of the first portion of the plurality of polymeric bushings 170 may engage with the plurality of recesses 72. As mentioned above, when received in plurality of recesses 72, the first portion of plurality of polymeric bushings 170 may function as springs. As best shown in FIG. 8 and FIG. 9, outer diameter 232 of first polymeric bushing 210 may be at least partially received in first recess 74 fixing first polymeric bushing 210 to bracket 50. Outer diameter 232 of second polymeric bushing 212 may be at least partially received in third recess 78 fixing second polymeric bushing 212 to bracket 50. Outer diameter 232 of third polymeric bushing 214 may be at least partially received in second recess 76 fixing third polymeric bushing 214 to bracket 50. Outer diameter 232 of fourth polymeric bushing 216 may be at least partially received in fourth recess 80.

As best shown in FIG. 6A and FIG. 6B, a second portion of the plurality of polymeric bushings 170 may be received in one of first aperture 164 or second aperture 166 of body 160. Outer diameter 232 of the second portion of the plurality of polymeric bushings 170 may engage body 160 at the first aperture 164 and/or the second aperture 166. While inner diameter 230 of fifth polymeric bushing 218 is fixed to first rod 168, outer diameter 232 of fifth polymeric bushing 218 is fixed to body 160. Inner diameter 230 of sixth polymeric bushing 220 is fixed to second rod 169 and outer diameter 232 of sixth polymeric bushing 220 is fixed to body 160. The configuration of the fifth polymeric bushing 218 fixed to the first rod 168 and body 160 and the sixth polymeric bushing 220 fixed to the second rod 169 and body 160 prevents rotation of first rod 168 and second rod 169 relative to body 160.

With renewed reference to FIGS. 1-3, when hood 14 is in the closed position (FIG. 1), hood 14 is releasably secured to body 12 via hood mount 18. First portion 20 includes bracket 50 fixed to body 12 and receiver assembly 54 at least partially disposed within cavity 68 of bracket 50 (FIG. 3). Receiver assembly 54 is fixed to bracket 50 via the plurality of polymeric bushings 170 (i.e., bracket 50 is fixed to the first rod 168 and the second rod 169 via polymeric bushings 170 fixed to first rod 168 and second rod 169).

Second portion 22 (FIG. 1) includes plunger assembly 52 fixed to hood 14 (e.g., via plate 90). When hood 14 is closed, plunger 94 is movably received in receiver assembly 54 (FIG. 3). Specifically, as shown in FIG. 6A and FIG. 6B, tapered surface 110 of plunger 94 contacts and engages tapered seat 162 of body 160. In this position, a portion of plunger may protrude from the bottom end 178 of body 160.

Because the first angle of tapered surface 110 and second angle of tapered seat 162 of body 160 are complimentary, the engagement between tapered surface 110 and tapered seat 162 prevents movement between plunger 94 and body 160 in the first direction 130 (FIG. 3). In other words, when plunger 94 is engaged with body 160, movement of hood 14 relative to body 12 is limited in first direction 130 and hood 14 is releasably secured to body 12.

As mentioned above, the plurality of polymeric bushings 170 are partially received in the plurality of recesses 72 of bracket 50. Because the plurality of polymeric bushings 170 are radially stiff and torsionally compliant, they act as springs preventing relative motion between hood 14 and body 12 in first direction 130 but permitting relative motion between hood 14 and body 12 in second direction 132. This allows hood 14 to releasably secure to body 12 while minimizing frictional noise between components.

When hood 14 is in the open position (FIG. 2), plunger 94 is released from receiver assembly 54. In the open position, tapered surface 110 of plunger 94 is spaced apart from tapered seat 162 of body 160. When plunger 94 is released from receiver assembly 54, plunger assembly 52 is not engaged to receiver assembly 54. Thus, hood 14 is released and may move relative to body 12.

Referring to FIG. 10, a hood mount 318 is shown, which may be the same as or similar to hood mount 18 of FIGS. 1-9, except as described below. Vehicle 10 may include hood mount 318 to releasably secure hood 14 and body 12 between the closed (FIG. 1) and open (FIG. 2) positions.

Hood mount 318 includes a bracket 320, a plunger assembly 322 and a receiver assembly 324. Bracket 320 includes two sets of parallel walls, including a first wall (not shown), an opposite second wall 328, a third wall 330, and an opposite fourth wall 332. First wall, second wall 328, third wall 330 and fourth wall 332 may be joined to define a cavity 334 therebetween. A first or top surface 336 of bracket 320 may define a first recess and a second recess disposed on first wall, and a third recess 338 and a fourth recess 339 disposed on second wall 328.

Plunger assembly 322 includes a plate 340, a post 342, and a plunger 344. Post 342 extends from a surface of plate 340. Post 342 may include a hollow body 346 including an outer surface 348 and an inner surface 350. A helical depression (e.g., a female thread) may extend radially around inner surface 350. In the configuration shown in FIG. 10, hollow body 346 has a generally cylindrical shape (e.g., a cup-shape), although other shapes and configurations are possible.

Plunger 344 includes a plunger body 352 defining a tapered depression 354. While the figures depict tapered depression 354 as being a conically shaped depression, it should be appreciated that other tapered shapes and configurations are possible (e.g., tapered depression 354 that has a pyramidal and/or polyhedron shape).

A helical ridge (e.g., a male thread) may extend circumferentially around an outer surface 356 of plunger 344 to improve engagement between post 342 and plunger 344. Plunger 344 may be threadingly received within post 342. To adjust the closed position of the hood (FIG. 1), plunger 344 may be rotated relative to post 342 to move post 342 between a first position and a second position in first direction 130. In the first position (FIG. 10), a portion 358 of inner surface 350 of post 342 may be spaced apart from plunger 344. In the second position (not shown), plunger 344 may be in contact with portion 358 of inner surface 350. Post 342 may have an adjustment in first direction 130 of about ±10 mm relative to plunger 344 between first and second positions.

Plunger assembly 322 may further include a locking mechanism (not shown, see, e.g., locking mechanism 150 of FIGS. 6A and 6B) disposed and/or embedded within plunger 344. Locking mechanism may engage with post 342 and plunger 344 to prevent rotation of post 342 relative to plunger 344.

Tapered depression 354 includes a first diameter at a first end 362 (e.g. a distal end) and a second diameter at a second end 366. Tapered depression 354 is tapered at a third angle between first end 362 and second end 366 such that first diameter is larger than second diameter. Third angle of tapered depression 354 is steep enough to allow easy engagement of plunger assembly 322 to receiver assembly 324 to secure hood 14 to body 12 in the closed position and shallow enough to allow disengagement of plunger assembly 322 and receiver assembly 324 when sufficient force is applied.

Receiver assembly 324 includes a receiver body 380 including a tapered protrusion 382. While the figures depict tapered protrusion 382 to have a conical shape, other tapered shapes and configurations are contemplated (e.g., tapered protrusion 382 having a pyramidal and/or polyhedron shape). The shape of tapered protrusion 382 may be complimentary to the shape of tapered depression 354.

Receiver body 380 further includes a first aperture 384, a second aperture 386, a first rod 388 extending through first aperture 384 and a second rod 389 extending though second aperture 386, and a plurality of polymeric bushings 390. Receiver assembly 324 may be at least partially disposed in cavity 334 of bracket 320.

Tapered protrusion 382 has a third diameter at a third end 396 and a fourth diameter at a fourth end 400. Tapered protrusion 382 is tapered at a fourth angle between third end 396 and fourth end 400 such that third diameter is larger than fourth diameter. Fourth angle of tapered protrusion 382 is complimentary to third angle of tapered depression 354. A surface 392 of tapered protrusion 382 may be coated (e.g., e-coated and/or coated with an elastomeric material). Additionally or alternately, tapered depression 354 may be coated (e.g., e-coated and/or coated with an elastomeric material).

First rod 388 may extend between a first end (not shown) and a second end (not shown). Second rod 389 may extend between a third end (not shown) and a fourth end (not shown). The plurality of polymeric bushings 390 may include a first polymeric bushing (not shown) fixed to first end of first rod 388, a second polymeric bushing 406 fixed to second end of first rod 388, a third polymeric bushing (not shown) fixed to third end of second rod 389, and a fourth polymeric bushing 408 fixed to fourth end of second rod 389. The plurality of polymeric bushings 390 further includes a fifth polymeric bushing 410 fixed to a first bottom portion of first rod 388 and a sixth polymeric bushing 414 fixed to a second bottom portion of second rod 389.

A first portion of the plurality of polymeric bushings 390 may be at least partially received in the recesses of bracket 320. Specifically, first polymeric bushing may be at least partially received in first recess. Second polymeric bushing 406 may be at least partially received in third recess 338. Third polymeric bushing may be at least partially received in second recess. Fourth polymeric bushing 408 may be at least partially received in fourth recess 339.

A second portion of the plurality of polymeric bushings 390 may be received in one of first aperture 384 or second aperture 386. As shown in FIG. 10, fifth polymeric bushing 410 fixed to first rod 388 may be received in first aperture 384. Sixth polymeric bushing 414 fixed to second rod 389 may be received in second aperture 386.

When hood 14 is secured to body 12 in the closed position (FIG. 1), tapered protrusion 382 of receiver assembly 324 is engaged with tapered depression 354 of plunger assembly 322. Because the third angle of tapered depression 354 and fourth angle of tapered protrusion 382 are complimentary, the engagement between tapered protrusion 382 and tapered depression 354 prevents movement between plunger body 352 and receiver body 380 in first direction 130. In other words, when plunger body 352 is engaged with receiver body 380, movement of hood 14 relative to body 12 is limited in first direction 130 and hood 14 is releasably secured to body 12.

The plurality of polymeric bushings 390 are partially received in the recesses of bracket 320. Because the plurality of polymeric bushings 390 are radially stiff and torsionally complaint, they act as springs preventing relative motion between hood 14 and body 12 in second direction 132. In this way, hood mount 318 allows hood 14 to releasably secure to body 12 while minimizing frictional noise between components.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A hood mount for a vehicle including a hood movably coupled to a vehicle body, the hood mount comprising:
a bracket including first, second, third and fourth recesses and a flange adapted to be mounted to one of the vehicle body or the hood;
a plunger assembly comprising a plate adapted to be mounted to the other of the vehicle body or the hood, a post extending from a surface of the plate, and a plunger including a tapered surface; and
a receiver assembly comprising a body defining a tapered seat, a first aperture and a second aperture extending through the body, a first rod including a first end and an opposite second end, a second rod including a third end and an opposite fourth end, the first rod extending through the first aperture and the second rod extending through the second aperture, a plurality of polymeric bushings including a first polymeric bushing fixed to the first end of the first rod, a second polymeric bushing fixed to the second end of the first rod, a third polymeric bushing fixed to the third end of the second rod, and a fourth polymeric bushing fixed to the fourth end of the second rod,
the first polymeric bushing being received in the first recess, the second polymeric bushing being received in the second recess, the third polymeric bushing being received in the third recess, and the fourth polymeric bushing being received in the fourth recess,
wherein in a first position, the tapered surface of the plunger is spaced apart from the tapered seat of the body, and
wherein in a second position the tapered surface of the plunger contacts the tapered seat of the body.

2. The hood mount of claim 1, wherein a first angle of the tapered surface and a second angle of the tapered seat are complimentary.

3. The hood mount of claim 1, wherein the plurality of polymeric bushings is formed of an elastomeric material.

4. The hood mount of claim 3, wherein the elastomeric material resists deflection in a radial direction and is compliant in a torsional direction.

5. The hood mount of claim 1, wherein each of the first rod and the second rod include a bottom portion, a first leg portion extending orthogonally from the bottom portion, and an opposite second leg portion extending orthogonally from the bottom portion.

6. The hood mount of claim 5, wherein the plurality of polymeric bushings further includes a fifth polymeric bushing fixed to the bottom portion of the first rod and a sixth polymeric bushing fixed to the bottom portion of the second rod.

7. The hood mount of claim 6, wherein the fifth polymeric bushing and the sixth polymeric bushing are fixed to the body of the receiver assembly, the fifth polymeric bushing being disposed in the first aperture and the sixth polymeric bushing being disposed in the second aperture.

8. The hood mount of claim 1, wherein when in the second position, the plunger and the body cooperate to prevent movement of the hood relative to the vehicle body in a first direction and wherein when in the second position, the plunger and the body cooperate to permit movement of the hood relative to the vehicle body in a second direction.

9. The hood mount of claim 8, wherein the tapered surface of the plunger is a conical surface, and wherein the tapered seat of the body is a conically shaped seat.

10. The hood mount of claim 1, wherein the post is movably received within the plunger between a first position and a second position.

11. The hood mount of claim 10, wherein a dimension between the first position and the second position is about 10 millimeters (mm).

12. The hood mount of claim 10, further comprising a locking mechanism embedded in the plunger and engaged with the post to restrict rotation of the post relative to the plunger.

13. The hood mount of claim 1, wherein the body of the receiver assembly is positioned within a cavity of the bracket.

14. The hood mount of claim 1, wherein the bracket is adapted to be fixed to the vehicle body and the plunger assembly is adapted to be fixed to the hood.

15. A hood mount for a vehicle including a hood movably coupled to a vehicle body, the hood mount comprising:
a bracket including a first recess, a second recess, a third recess, a fourth recess, and a flange adapted to be mounted to one of the vehicle body or the hood;
a plunger assembly comprising a plate adapted to be mounted to the other of the vehicle body or the hood, a post extending from a surface of the plate, and a plunger including a tapered surface; and
a receiver assembly comprising,
a body defining a tapered seat,
a first aperture and a second aperture extending through the body,
a first rod including a first bottom portion, a first end and an opposite second end,
a second rod including a second bottom portion, a third end and an opposite fourth end, the first bottom portion of the first rod extending through the first aperture and the second bottom portion of the second rod extending through the second aperture,
a first polymeric bushing fixed to the first end of the first rod and received in the first recess, a second polymeric bushing fixed to the second end of the first rod and received in the second recess, a third polymeric bushing fixed to the first bottom portion of the first rod, a fourth polymeric bushing fixed to the third end of the second rod and received in the third recess, a fifth polymeric bushing fixed to the fourth end of the second rod and received in the fourth recess, and a sixth polymeric bushing fixed to the second bottom portion of the second rod,
wherein in a first position, the tapered surface of the plunger is spaced apart from the tapered seat of the body, and
wherein in a second position the tapered surface of the plunger contacts the tapered seat of the body.

16. The hood mount of claim 15, wherein each of the polymeric bushings is formed of an elastomeric material that resists deflection in a radial direction and is compliant in a torsional direction.

17. The hood mount of claim 15, wherein,
a first inner diameter of the first polymeric bushing, a second inner diameter of the second polymeric bushing, and a third inner diameter of the third polymeric bushing are fixed to the first rod and a fourth inner diameter of the fourth polymeric bushing, a fifth inner diameter of the fifth polymeric bushing, and a sixth inner diameter of the sixth polymeric bushing are fixed to the second rod,
a first outer diameter of the first polymeric bushing and a second outer diameter of the second polymeric bushing are fixed to the respective first and second recesses,
a third outer diameter of the third polymeric bushing is disposed within the first aperture and fixed to the body,
a fourth outer diameter of the fourth polymeric bushing and a fifth outer diameter of the fifth polymeric bushing are fixed to the respective fourth and fifth recesses, and
a sixth outer diameter of the sixth polymeric bushing is disposed within the second aperture and fixed to the body.

18. A hood mount for a vehicle including a hood movably coupled to a vehicle body, the hood mount comprising:
a bracket including first, second, third and fourth recesses and a flange adapted to be mounted to one of the vehicle body or the hood;
a plunger assembly comprising a plate adapted to be mounted to the other of the vehicle body or the hood, a post extending from a surface of the plate, and a plunger defining a tapered depression; and
a receiver assembly comprising a receiver body including a tapered protrusion, a first aperture and a second aperture extending through the receiver body, a first rod including a first end and an opposite second end, a second rod including a third end and an opposite fourth end, the first rod extending through the first aperture and the second rod extending through the second aperture, a plurality of polymeric bushings including a first polymeric bushing fixed to the first end of the first rod, a second polymeric bushing fixed to the second end of the first rod, a third polymeric bushing fixed to the third end of the second rod, and a fourth polymeric bushing fixed to the fourth end of the second rod,
the first polymeric bushing being received in the first recess, the second polymeric bushing being received in the second recess, the third polymeric bushing being received in the third recess, and the fourth polymeric bushing being received in the fourth recess,
wherein in a first position, the tapered depression of the plunger is spaced apart from the tapered protrusion of the receiver body, and
wherein in a second position the tapered depression of the plunger contacts the tapered protrusion of the receiver body.

19. The hood mount of claim 18, wherein a first angle of the tapered depression and a second angle of the tapered protrusion are complimentary.

20. The hood mount of claim 18, wherein when in the second position, the plunger and the receiver body cooperate to prevent movement of the hood relative to the vehicle body in a first direction and to permit movement of the hood relative to the vehicle body in a second direction.
